(19) United States
(12) Patent Application Publication
(10) Pub. No.: US 2014/0279212 A1
(43) Pub. Date: Sep. 18, 2014

(54) MULTI-CHANNEL WIRELESS PRE-APPROVAL SYSTEM

(71) Applicant: Simplexity, LLC, Reston, VA (US)

(72) Inventors: Frank Bennett, McLean, VA (US); Tim Weisbrod, Arlington, VA (US); Greg Favinger, Ellicott City, MD (US); Grant Yoder, Arlington, VA (US); Jeff Baskin, Arlington, VA (US); Renee Clark, Fairfax, VA (US); Rob Chiatello, Hamilton, VA (US)

(21) Appl. No.: 13/836,652

(22) Filed: Mar. 15, 2013

(51) Int. Cl. G06Q 30/06

(52) U.S. Cl. CPC G06Q 30/0601; G06Q 30/0633
USPC 705/26.8; 705/26.1

(57) ABSTRACT

Methods and systems are provided for the simultaneous submission of pre-approval requests to multiple wireless carriers prior to the purchase of wireless devices, wireless service plans and/or accessories. Methods and systems are also provided for a sophisticated inventory management system for one or more wireless device retail stores that all supports interactive customer returns processing at a self-service kiosk. Methods and systems are further provided for synchronizing a wireless device transaction between a self-service kiosk and retail store point of sale system so that a customer may start the transaction at the kiosk and complete it at the point of sale system. Methods and systems are also provided for browsing and configuring a wireless device, accessories, activation type and associated rate plan into a wireless device bundle prior to purchasing the selected wireless device bundle.

### FIELD OF THE INVENTION

The present invention relates generally to the fields of Software as a Service (SaaS) applications and electronic commerce for the purchase, activation, returns processing and inventory management of wireless devices, wireless services and/or accessories. More specifically, the invention relates to systems and methods for processing customer pre-approval requests simultaneously for multiple wireless carriers prior to the purchase of wireless devices, wireless service plans and/or accessories. This invention further relates to systems and methods for providing a sophisticated inventory management system for one or more wireless device retail stores that all supports interactive customer returns processing at a self-service kiosk. The invention also relates to systems and methods for synchronizing a wireless device transaction between a self-service kiosk and retail store point of sale system so that a customer may start the transaction at the kiosk and complete it at the point of sale system. The invention also relates to systems and methods for browsing and configuring a wireless device, accessories, activation type and associated rate plan into a wireless device bundle prior to purchasing the selected wireless device bundle.

### BACKGROUND OF THE INVENTION

Wireless service providers are constantly racing to provide customers with the latest wireless devices, wireless service plans and/or accessories associated with wireless devices or wireless service plans (“Wireless Product”). Popular mechanisms for offering these Wireless Products to customers are via the use of purchase and activation portals (“portal”) that may be accessible online or via terminals located in retail stores. Before customers decide to purchase, upgrade or renew (collectively “Purchase”) Wireless Products, they are often interested to find out whether they are eligible for an upgrade to their existing Wireless Products or whether they meet a wireless carrier's eligibility for new Wireless Products. For example, conventionally, if a customer such as a post-paid customer (customers that receive monthly bills for the phone service, unlike pre-paid customers, who must pay for their service first before their phones will work) wants to determine their eligibility for new Wireless Products, they may have to select a particular wireless carrier; contact the select wireless carrier; provide the wireless carrier's customer service representative (“CSR”) with the customer's appropriate information, including the customer's name, address, Social Security number and driver's license (or state ID) number; receive a response from the CSR, after the CSR runs the customer's credit to determine whether the customer will require a deposit to open a new line of service or whether the customer is approved for the Wireless Product. At this point, the customer may then select a desired Wireless Product for purchase from the CSR. Conventional systems for the purchase of Wireless Products may provide a single wireless carrier pre-approval while customers are logged on to their websites prior to orders for Wireless Products being submitted. These conventional systems may also prevent orders from being submitted if wireless carrier systems are unavailable. Conventional systems for purchasing a Wireless Product at a retail store require the intervention of a CSR and do not provide a self-service option for a customer to browse and configure a Wireless Product bundle themselves or when a CSR is not available. These conventional systems may also require dual entry of order information between self-service kiosks and retail store point-of-sales for orders that were initiated at a self-service kiosk. Conventional systems fail to provide accurate information to Wireless Product retailers for tracking the location of specific Wireless Products to support device recalls, prevent loss/theft, and assist with multi-channel activation functionality.

### SUMMARY OF THE INVENTION

The invention provides a system with modules, including but not limited to a Multi-Channel Wireless Carrier Pre-Approval (“MWCP”) module, a Wireless Products purchase code generation module (PCM), a serialized inventory management module (“Inventory System”), and a Wireless Product retail store point of sale integration module (“POS Integration”) (collectively “platform”). MWCP provides for the simultaneous submission and processing of pre-approval requests to multiple wireless carriers. MWCP also provides a user interface (“UI”), where a customer may evaluate and/or review the response received from each of the wireless carriers. PCM provides for a customer to review, browse and/or configure Wireless Product bundles before a customer decides to purchase the configured Wireless Product bundles. IM provides for the Wireless Product inventory management at one or more Wireless Product retail store, with an interactive UI for CSR or managers to track serialized inventory data and an interactive UI for customers or CSR to process the returns of Wireless Products. POS Integration provides an integration component for the platform to synchronize all elements of a Wireless Product transaction with retailer POS systems.

Embodiments of the present invention may include computer-implemented method for submitting a plurality of pre-approval requests simultaneously to multiple wireless carriers. The method capable of performing at least the following steps of: receiving a pre-approval request from a user, wherein the pre-approval request contains an indication of the selection of multiple wireless carriers from a database of available wireless carriers and user information; submitting the pre-approval to one or more systems for the selected multiple wireless carriers; generating a unique code for the pre-approval request; aggregating responses from the selected multiple wireless carriers; displaying the generated unique code, user information and the aggregated responses on a UI for the user review and selection; and providing the user with an option to store, print, email or send via SMS the displayed generated unique code for a future purchase of wireless products.

Embodiments of the present invention may include computer-implemented method for purchasing wireless products and services with a pre-approval indicator. The method capable of performing at least the following steps of: receiving a pre-approval indicator and other user information from a user; transmitting the pre-approval code and the user information to other systems to lookup the pre-approval indicator data; displaying the pre-approval indicator, user information and aggregated pre-approval request responses from multiple wireless carriers associated with the received pre-approval indicator; receiving a selection from the user of one wireless carrier from the multiple wireless carriers, wherein the selected wireless carrier provided the user with a positive pre-approval response; displaying wireless products from a database of available wireless products from the selected wireless carrier receiving an order with an indication of the selected wireless product; validating the order with one or more validation routines; and transmitting the validated order to one or more systems for processing.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is an illustration of the exemplary system architecture of the platform according to one embodiment of the invention.

FIG. 2 is an illustration of a high level flow chart of an exemplary process for browsing, configuring or selecting a Wireless Product bundle prior to purchasing the Wireless Product bundle according to one embodiment of the invention.

FIG. 3 is an illustration of a high level flow chart of an exemplary process for obtaining a pre-approval simultaneously from multiple wireless carriers according to one embodiment of the invention.

FIG. 4 is an illustration of a self-service portal screen according to one embodiment of the invention.

FIG. 5 is an illustration of an associate log in screen for a Wireless Products Portal according to one embodiment of the invention.

FIG. 6 is an illustration of a Wireless Product Portal home page according to one embodiment of the invention.

FIG. 7 is an illustration of a multiple wireless carrier pre-approval request UI for a new Wireless Product according to one embodiment of the invention.

FIG. 8 is and illustration of a multiple wireless carrier pre-approval request UI for adding a line to an existing Wireless Product account according to one embodiment of the invention.

FIG. 9 is an illustration of pre-approval results UI where one or more wireless carriers has denied pre-approval or requires additional information according to one embodiment of the invention.

FIG. 10 is an illustration of a UI for browsing and selecting phones according to one embodiment of the invention.

FIG. 11 is an illustration of a UI for adding a new line to an existing Wireless Product account according to one embodiment of the invention.

FIG. 12 is an illustration of a details and plan selection UI for adding a line to an existing Wireless Product account according to one embodiment of the invention.

FIG. 13 is an illustration of a single wireless carrier pre-approval request UI for a Wireless Product upgrade or renewal according to one embodiment of the invention.

FIG. 14 is an illustration of an upgrade eligibility and pre-approval results UI for Wireless Product upgrade or renewal according to one embodiment of the invention.

FIG. 15 is an illustration of a pre-approval results UI with options for a customer to browse phones or other Wireless Products and print, email or send by SMS pre-approval code or results according to one embodiment of the invention.

FIG. 16 is an illustration of a UI with a special offer generated by the platform that may be displayed before or after the customer submits their pre-approval results to purchase a Wireless Product according to one embodiment of the invention.

FIG. 17 is an illustration of a UI for inputting a customer pre-approval code or scanning Wireless Product UPC or browsing Wireless Products according to one embodiment of the invention.

FIG. 18 is an illustration of a UI for selecting related Wireless Products features or rate plans according to one embodiment of the invention.

FIG. 19 is an illustration of a UI for reviewing a Wireless Products order at a retail store according to one embodiment of the invention.

FIG. 20 is an illustration of a UI for checkout with pre-approval code for a Wireless Product according to one embodiment of the invention.

FIG. 21 is an illustration of a UI for a CSR to enter a Wireless Product electronic serial numbers (ESN), subscriber identity module (SIM) or other serial number according to one embodiment of the invention.

FIG. 22 is an illustration of a UI for providing a customer with an option to enter information for a purchased Wireless Product to be shipped to a retail store according to one embodiment of the invention.

FIG. 23 is an illustration of pop-up UIs during the pre-approval process where a wireless carrier requires additional information from the customer or has not approved a pre-approval request according to one embodiment of the invention.

FIG. 24 is an illustration of pop-up UIs during the pre-approval process displaying a pre-approval code, and providing the customer with an option to email the pre-approval to an email address or present it to a CSR at a retail store and a sample email with a customer's pre-approval response according to one embodiment of the invention.

FIGS. 25-29 are sample Inventory System UI in which a CSR or Manager at a Wireless Product retail store manages the Wireless Product inventory of one or more stores according to one embodiment of the invention.

FIGS. 30-32 as sample Inventory System UI in which a CSR or customer uses an interactive kiosk to process the return of a Wireless Product according to one embodiment of the invention.

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical or structural changes may be made to the invention without departing from the spirit or scope of this disclosure. To avoid detail not necessary to enable those skilled in the art to practice the embodiments described herein, the description may omit certain information known to those skilled in the art. The following detailed description is, therefore, not to be taken in a limiting sense.

### DETAILED DESCRIPTION OF THE INVENTION

As used herein, AJAX is a development technology for developing Web applications that adapts a client side script and an Application and/or web server 107 to asynchronously exchange data using the HTTP protocol. AJAX provides for the creation of interactive web applications that makes web pages feel more responsive by exchanging small amounts of data between a web page and an application and/or web server 107 and making page user interface updates incrementally, without having to reload the entire page. By using AJAX, a richer and more dynamic Web application user interface can be created. Its low response times and high availability can approach the properties of a local desktop application. AJAX is a part of the JavaScript 1.3 standard and is supported by most mainstream browsers.

As used herein, a “User Interface (UI)” may be a singular application, or alternatively a collection of inter-related apps, running on one or more servers (not shown) that is accessed over a network such as the Internet 105 or an intranet (not shown), with a web browser, which displays content to a user, accepts user input, and provides output by generating web pages which are transmitted via a network such as the Internet 105 or an intranet (not shown). Newer implementations utilize Hyper Text Markup Language version 5 (HTML 5), Java, AJAX, Adobe Flex, Microsoft .NET, or similar technologies to provide real time control in a separate program, eliminating the need to refresh a traditional HTML based web browser. A UI may also mean a computer software that is hosted in a browser-controlled environment (e.g. a Java applet) or coded in a browser-supported language (such as JavaScript, combined with a browser-rendered markup language like HTML) and reliant on a common web browser to render the application executable.

As used herein, a “database” may be a relational database, flat file database, relational database management system, object database management system, operational database, data warehouse, hyper media database, post-relational database, hybrid database models, RDF database, key value database, XML database, XML store, text file, flat file or other type of database.

As used herein, “authentication” refers to any authentication and access control mechanisms employed for granting access to computer systems, including but not limited to usernames, passwords, user identification number, biometric data, facial characteristics, voice, tokens or other objects from a single-sign-on (SSO) or identity server, two-factor authentication, multi-factor authentication or other conventional authentication mechanism.

As used herein, a “workflow” broadly refers to a path and/or order of steps in which the platform may perform a task. The order or number of steps may vary in different embodiments.

As used herein, the term “real time” may include, but is not limited to, immediate, rapid, not requiring operator intervention, automatic, and/or programmed. Real time may include, but is not limited to, measurements in femtoseconds, picoseconds, nanoseconds, milliseconds, as well as longer, and optionally shorter, time intervals.

As used herein, a “rules engine” may include an expert system which is operable to produce an output as a function of a plurality of rules. A rules engine, in one embodiment, may include an expert computer system which utilizes and builds a knowledge base developed in the form of business rules and/or formulas to assist the user in decision-making.

As used herein, a “customer” or “user” refers, generally, to a user or CSR operating a client device with a UI that is engaged in, is engaged in, or will engage in a communication session (referred herein, generally, as a “visit”), typically via standard web browser software, with one or more servers in the platform.

As used herein, the term “Internet” shall incorporate the terms “Intranet”, “computer network” and “Extranet” and any references to accessing the Internet 105 shall be understood to mean accessing an Intranet and/or Extranet and/or publicly accessible computer networks and private computer networks, as well. Examples of the Internet 105 may also include an internal network such as an Ethernet or a Virtual Private Network (VPN), one or more wireless networks, a wired network, an extranet, an intranet, a PSTN, a private network, or any other communication network.

In some embodiments, the platform 100 may be implemented using a rules engine to automate business rules for ordering and activation of a Wireless Product. In some embodiments, the business rules for ordering and activation of a Wireless Product may be implemented as a real-time workflow using a rules engine. In some embodiments, the platform 100 may utilize an interactive dynamic AJAX-driven UI to provide a customer with the current status of an order in the workflow. In some embodiments, the platform 100 may ensure that all required steps in an online submitted customer order occur in rapid succession while a customer is engaged. In some embodiments, the platform 100 may provide interactive UI to allow customers to provide information, make decisions, and/or trigger additional steps in the workflow. In some embodiments, the platform 100 may provide customers with an opportunity to automatically correct or adjusting existing wireless plans, if they already have accounts with wireless carriers for a selected wireless product. In some embodiments, Wireless Products may be sold with or without a wireless carrier service. In some embodiments, the platform 100 may interface with multiple wireless carrier systems for risk assessment, service provisioning, wireless device activation, and other transactions. In some embodiments, one or more of these transactions may be performed manually by CSRs or agents of a provider or wireless carrier. Further, embodiments of the invention do not require store personnel to be trained to use ordering and activation systems associated with multiple carriers

In some embodiments, the platform 100 may be implemented via one or more client devices, including but not limited to personal computers 101, notebooks 101, netbooks 101, tablets 102, cell phones 104, iPADs 102, PDAs 103 or other electronic device capable of supporting a browser. Each client device may be well known to those skilled in the art and may include a display, a central processor, a system memory, and a system bus that couples various system components including the system memory to the central processor unit. The system bus may be any of several types of bus structures including a memory bus or memory controller, a peripheral bus, and a local bus using any of a variety of bus architectures. The structure of system memory may be well known to those skilled in the art and may include a basic input/output system (BIOS) stored in a read only memory (ROM) and one or more program modules such as operating systems, application programs and program data stored in random access memory (RAM). The computers may also include a variety of interface units and drives for reading and writing data and a database for storing data. The computing devices may run an Operating System (OS). The OS may include a shell, for providing transparent user access to resources such as application programs. The OS may include a kernel, which provides essential services required by other parts of OS and application programs. The services provided by the kernel include memory management, process and task management, disk management, and I/O device management. The OS may be the Linux Operating system, Microsoft Operating system or other operating systems.

Each computing device may be able to communicate with another computer via a network using a network interface, which is coupled to the system bus. The network may be an external network such as the Internet 105. The client devices that implement the platform 100 may be implemented on a variety of hardware platforms or implemented in a variety of software environments.

Applications running on or accessing these computing devices may include a browser, a rules engine, a workflow application or other application required by the platform 100. A browser may include program modules and instructions for enabling a World Wide Web (WWW) client to send and receive network messages to the Internet 105. The browser may use well known protocols, such as Hyper Text Transfer Protocol (HTTP) messaging to enable communication with other computing devices.

In some embodiments, the platform 100 may be implemented using a net-centric Application Service Provider (ASP) model, which includes but may not be limited to a model wherein an application may be hosted on an application and/or web server 107, which can be accessed by the Internet 105 or a network. In one alternative, the present invention may be embodied in a computer program, typically an application program running on one or more application and/or web servers 107. Although the illustrative embodiment will be generally described in the context of an application running on an application and/or web server 107, otherwise known as an ASP model, those skilled in the art will recognize that the present invention may be implemented in any distributed computing environment including local area networks, wide area networks, as well as the Internet 105. The network may include permanent connections, such as wire or fiber optic cables, or temporary connections made through telephone or wireless communications. The distributed computing environments may include the Internet 105 with networks representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), and others.

In some alternatives, the platform 100 may operate in a model using a browser to access one or more computers via AJAX or using communication protocols, such as the Simple Object Access Protocol (SOAP) protocol. In some embodiments, MCWP may provide comprehensive reporting capabilities, which may provide an insight in profitability and category mix. In some embodiments, MCWP may provide a customer with a multi-channel capabilities to purchase Wireless Products pre-approved online or at a retail store or club and delivered to the customers home, picked-up at a retail store or club or shipped to a retail club or store if it is not available at the retail store. In some alternatives, the MCWP may optimize Wireless Products rate plans and features.

In one embodiment, the PCM may be used by a customer to select, browse or configure Wireless Products and associated accessories, activation type, rate plans, optional features or upsells into a Wireless Product bundle prior to the customer making a decision to purchase the Wireless Product bundle. Now referring to FIG. 2, there is shown a high level flow chart of an exemplary process for browsing, configuring or selecting a Wireless Product bundle prior to purchasing the Wireless Product bundle according to one embodiment of the invention. The self-service purchase code process begins the workflow at step 201, in which a customer may select an option to browse Wireless Products from a Wireless Product portal 501. In step 202, the PCM may provide the customer or CSR with a UI to browse Wireless Products, activation types and configure rate plans for the selected Wireless Products. In some alternatives, if the user has completed configuring their selected Wireless Product, the PCM may generate a purchase code as illustrated in step 205. In step 203, the PCM may provide the customer or CSR with a UI to select and browse optional features and/or upsells associated with the selected Wireless Product. In some alternatives, if the user has completed configuring their selected Wireless Product, the PCM may generate a purchase code as illustrated in step 205. In step 204, the PCM may provide the customer or CSR with an option to review the selected Wireless Product bundle. In step 205, the PCM may generate a purchase code that represents the selected Wireless Product. In some alternatives, the purchase code may be an alpha code, a numeric code or an alpha-numeric code. In some alternatives, the purchase code may be displayed as character data or bar code data. In some alternatives, the PCM may provide a link for a CSR to assist a customer at a self-service kiosk to complete that order. Optionally, in step 206, the customer may use the purchase code to purchase the configured Wireless Product bundle through a Virtual Inventory Program and/or Real-Time Order and Activation system.

Alternatively in step 206, a customer may print, email or send a purchase code via SMS messaging to themselves or a CSR at a retail store to complete the purchase of the Wireless Product bundle. In step 211, after a customer presents a purchase code to a CSR, the CSR may log into a self-service kiosk or retail POS system. In step 210 the CSR may submit the purchase code to one or more databases to lookup the Wireless Product bundle for the submitted purchase code. In some alternatives, the PCM may provide a UI such as a bar code reader for scanning a printed copy of the purchase code. In some alternatives, the purchase code may be stored or available in the customer's online session from steps 201-204. In some alternatives, the CSR may complete steps 202, 204, 206 and 314 to modify the Wireless Products and/or complete the transaction.

Alternatively in step 211, the CSR may log in to a self-service kiosk or retail POS system. In step 212, the CSR may access a merchandise page UI generated by the PCM, which displays all Wireless Products available through that retail store. The CSR will then complete steps 202, 203, 204, 206 to complete the Wireless Product transaction. In some alternatives, after the transaction has been submitted to a Real-Time Order and Activation system, in step 207, the PCM may assign inventory to fulfill the Wireless Product bundle in the transaction. In step 208, the CSR may use the PCM to activate the selected Wireless Product. Finally, in step 209, the customer may checkout at the retail store POS to complete the transaction.

In some alternatives, when the purchase case is provided to a CSR, it may allow the CSR to pick up exactly where the customer left off, including all the configured portions of the wireless bundle the customer has already selected and all the contents currently in their cart. In some alternatives, the PCM may allow a customer to use a virtual inventory program to have a Wireless Product shipped to their home or to a retail store without requiring any assistance from a CSR. In some alternatives, the PCM may be used regardless of whether a CSR is currently present or available. If a CSR is present they can continue the purchase either on the same self-service terminal, or on a separate machine when provided with the purchase code either by manual entry or scanning a barcode included on the print out or email.

In another embodiment, the MCWP may be used to submit one or more pre-approval requests simultaneously to multiple wireless carriers for processing. Now referring to FIG. 3, there is shown a high level flow chart of an exemplary MCWP workflow for submitting one or more pre-approval requests simultaneously to multiple wireless carriers for processing and utilizing positive pre-approval responses to aid the purchase of desired Wireless Products. The pre-approval process begins the workflow at step 301, in which a customer may access a Wireless Products portal from self-service or CSR assisted terminals located at a brick and mortar store or online using a browser on a client device as illustrated in FIG. 4. In some alternatives, the customer may be prompted with an authentication UI. In some alternatives, the customer may also be prompted with a UI to enter additional information, such as a buyer's club number, zip code or CSR name as illustrated in FIG. 5. In step 302, the MCWP may provide the user with a UI to select from one of the following options: whether they already have a pre-approval notification; whether they may like to be pre-approved for a Wireless Product; whether they would like to purchase prepaid Wireless Products; or whether they would to make updates to their account as illustrated in FIG. 6. In some alternatives, the pre-approval notification may include a pre-approval indicator, the customer's name, and/or pre-approval responses from the wireless carriers selected by the customer. If the customer does not have a pre-approval notification, then the user may opt to get pre-approved for a Wireless Product, Browse Wireless Products, Buy pre-paid airtime or make updates to their account. If the user opts to buy pre-paid air time, the user may be provided with a UI to guide them through the workflow for purchasing and activating pre-paid Wireless Products. In some alternatives, the pre-approval indicator may be an alpha code, a numeric code or an alpha-numeric code. In some alternatives, the pre-approval indicator may be displayed as character data or bar code data. If the user opts to make updates to their wireless carrier accounts, the user will be provided with a UI to guide the user through making updates to their wireless carrier accounts. If the customer decides to browse the available Wireless Products from the portal's database, the customer will be provided with a UI to view the available Wireless Products for a particular wireless carrier as illustrated in FIG. 9.

If the user opts to create a new account for a Wireless Product, add a Wireless Product to an existing account or upgrade a Wireless product on an existing account, then in step 304, MCWP provides the user with a UI to select one or more wireless carriers, including but not limited to AT&T, Verizon Wireless, Sprint Nextel, T-Mobile, and the like. The UI may also have fields for submitting customer information such as, a first name, an optional middle initial, a last name, an address, an email address, customer's date of birth, a daytime phone number, a home phone number, Social Security number and driver's license (or state ID) number as illustrated in FIGS. 7, 8, 12 and 13. In some alternatives, MCWP may reformat the customer information in to an alternate format that may be required for each of the selected wireless carriers. In step 305, MCWP may display a response to the pre-approval request on a client device UI. In some embodiments, the response may include a unique pre-approval indicator, some basic information about the customer and the pre-approval results received from each of the selected wireless carriers as illustrated in FIG. 10. The MCWP may provide the user with multiple options to store the pre-approval response, such as printing the pre-approval response or sending a copy of the pre-approval response to the customer or a third-party using messaging services, such as email, voicemail, instant messaging, text messaging or other similar messaging services as illustrated in FIGS. 10, 16, 28. In step 307, if the user receives a positive response from their desired wireless carriers, the user may either continue shopping for a desired Wireless Product or use the pre-approval notification to shop for a Wireless Product at a different time as discussed below in step 311. If the user is denied by one or more of the wireless carriers, in step 308, the user may evaluate and/or review the pre-approval guidelines of other wireless carriers that provided a positive response on the pre-approval response and the user may then select an alternate wireless carrier as illustrated in 2701. If the MCWP indicates that one or more wireless carriers requires additional information or requires confirmation of information by the user, in step 309, the user will be prompted with a prompt to enter the additional information or verify the current information as illustrated in 2702. The user may then submit the new or verified information for pre-approval as illustrated in step 305 above.

If the user has a pre-approval code in step 302, or the user has received a pre-approval code from their selected wireless carriers in step 307, or if the user has received a pre-approval code and selected an alternate wireless carrier other than their preferred wireless carrier in step 310, then in step 311 the user may submit the pre-approval code and/or other customer information to the MCWP as illustrated in 1801. The MCWP may query one or more databases to lookup the pre-approval data for the submitted pre-approval code. In some alternatives, the MCWP may provide a UI such as a bar code reader for scanning a printed copy of the pre-approval code. In some alternatives, the pre-approval code may be stored or available in memory if the user's session from steps 302-306 is still active and the user may have elected to continue shopping for a Wireless Product after receiving a pre-approval code. In step 312, the customer may select a desired Wireless Product available from the selected wireless carrier by browsing the available products or scanning the UPC of a wireless product to be purchased as illustrated in 1802. In step 313, MCWP may provide the customer with a UI to review the details of the order as illustrated in FIGS. 19-21 before the user proceeds to checkout. In some alternatives, MCWP may also provide the user with options to complete the sale in a retail store, complete the sale and ship phone to customer's home or complete sale and ship phone to retail store for customer pickup. After the user selects one of these options, the order may be processed by a Real-Time Order and Activation system. In some alternatives, if the user opts to complete the sale in a retail store, MCWP may provide a CSR at the retail store with the ability to continue a user's order process from where the user suspended the process as illustrated in FIG. 21 before submitting the order to be processed by a Real-Time Order and Activation system.

In an alternative embodiment, the MCWP may be used to facilitate the purchase of Wireless Products online or at retail stores by individuals under a disability, such as minors, senior citizens, individuals with a physical disability, individuals under care or other individuals under the supervision of another individual. For example, a parent of a child may visit a warehouse club to add a Wireless Product to their existing Wireless Products account for their child. The parent may access a terminal configured with the platform's UI to access a Wireless Products portal. The parent may input a username and password to access their account when prompted by the platform. When prompted with a menu of options available, the parent may opt to add a wireless product to their existing account. The parent may submit all information requested by the MCWP for the requested wireless product. If the MCWP generates a positive response to the parent's request, the MCWP will display a pre-approval code, which the parent may print out, email or send via (Short Message Service) SMS messaging. After the child receives the approval code from the parent, the child may use the pre-approval code to access the MCWP either at a store or from a computer at their home and purchase the desired Wireless Product.

In one embodiment of the invention, the POS Integration may communicate and synchronize data with POS terminals located at Wireless Product retailer stores, so that the POS systems may track all components of a Wireless Product transaction. In some alternatives, the components of the Wireless Products transaction may be determined once the activation of a Wireless Product completes, and can be based on the Wireless Product Activated, the type of Activation, the wireless carrier/rate-plan activated, and any features activated, among other potential factors. In some alternatives, these components of a Wireless Product transaction may reduce the price of the Wireless Product when sold with activation; book additional back-end revenue expected from the Wireless Product vendor or wireless carriers as a result of the Wireless Product activation; support collecting any deposits required by the wireless carriers, or record credit for a Wireless Product store and/or CSR for the sale of a Wireless Product. In some alternatives, a Wireless Product retailer may integrate with the POS Integration by dynamically printing a POS receipt with one or many barcodes or store keeping units (SKUs) to represent each component in the Wireless Product transaction, where all of the printed barcodes or SKUs may be scanned in at a POS terminal. This integration may be dynamic and configurable to support Wireless Product retailers who may only need a single barcode/SKU by Wireless Product and/or Wireless Product activation type for certain Wireless Product transactions, or the integration may support Wireless Product retailers who may need multiple barcodes/SKUs for each aspect of the Wireless Product activation if they may need to record very detailed data in some cases. In some aspect of the invention, the POS Integration may integrate with APIs provided by the Wireless Product retailers to pre-setup all the components of a Wireless Product transaction at whatever granularity is desired. The POS Integration may accept and store a unique value returned by the Wireless Product retailer APIs, sometimes called a “Suspended Barcode”. The POS Integration may then generate a barcode with the unique value for the transaction returned by the Wireless Product retailer's APIs on the POS receipt after the Wireless Product activation completes. When scanned in at a POS the Wireless Product retailer systems would then record all the components of the Wireless Product transaction via a single scan. In some alternatives of the invention, the Platform may provide support for a printed POS receipt, which may include a barcode with a unique transaction or order number to access an API hosted on the Platform. Wireless Product retailer POS systems can call this API when they scan the barcode, which may return details on all the components of the wireless transaction.

In one embodiment of the invention, the Inventory System provides a complex inventory management system for managing and tracking the inventory at Wireless Product retail stores at a serialized level when recording and receiving Wireless Product inventory.

In some alternatives, the Inventory System may provide replenishment support at Wireless Product retail stores by setting the store-level thresholds for reordering additional Wireless Product Inventory. A CSR may access a Wireless Products portal from self-service or CSR assisted terminals located at a brick and mortar store or online using a browser on a client device as illustrated in FIG. 4. In some alternatives, the CSR may be prompted with an authentication UI for entering their authentication credential and for selecting the option for “Inventory Management”. After the “Inventory Management” option is selected, the CSR may be prompted with the following sub-options, “Receive Inventory”, “Inventory Reports” or “Place Order” as illustrated in FIG. 5. After the CSR submits the selected option, the Inventory System may respond with a UI prompting the CSR to choose a particular order as illustrated in FIG. 25. After the CSR has selected the desired order, the Inventory System may respond with a ‘Create New Received Shipment’ UI prompting the CSR to edit items within the selected order by clicking on a specific indicator related to that line item as illustrated in FIG. 26. The Inventory System may respond with the ‘Scan to Receipt’ UI that permits a CSR to scan barcodes, input unique identification numbers for Wireless Products, such as serial numbers, SIM card numbers, International Mobile Station Equipment Identity (IMEI) numbers or ESN numbers, or other Wireless Product tracking numbers as illustrated in FIG. 27. After the CSR submits their input in the ‘Scan to Receipt’ UI to the Inventory System, the Inventory System may provide a ‘Recent Equipment Records’ UI that may permit a CSR to post the Wireless product to the store's inventory, close received shipment, and scan additional Wireless Products as illustrated in FIG. 28.

In some alternatives, the Inventory System may provide a UI that allows a CSR to automate inventory searches, by generating query reports for a particular store, a division or all stores nationwide. The Inventory System may also generate a summary of in-store SKUs and/or serial numbers like IMEI, ESN or SIM for a particular store as illustrated in FIG. 29.

In some alternatives, the Inventory System may provide a UI to support manager-level logins, controls and adjustment flexibility at a store. Manual adjustment may be necessary due to Wireless Product transfers to other stores, damaged items or shrinkage.

In some alternatives, the Inventory System may also allow a customer or a CSR to process the return of a previously purchased Wireless Product. The CSR may be prompted with an authentication UI for entering their authentication credential and for selecting the option for “Process Returns” as illustrated in FIG. 5. In some alternatives, the Inventory System may prompt the CSR with a UI to capture the input for information related to the selected Wireless Product being returned, such as a customer's email address, account number, order number, ESN or IMEI number for the Wireless Product or other unique identification numbers for the selected Wireless Product to sign into the Wireless Product portal as illustrated in FIG. 30. In some alternatives, the Inventory System may be provide the user with a UI to search for the selected Wireless Product by Order ID, email address, account number, order number, mobile number, account telephone number, customer name, ESN or IMEI number for the Wireless Product or other unique identification numbers for the selected Wireless Product. After the CSR has located the order in the Inventory System related to the selected Wireless product, the CSR may submit a request to the Inventory System to process the request as illustrated in FIG. 31. The Inventory System generates a UI that allows the user to complete information about the Wireless Product being returned, such as the packaging condition, return reason and other return criteria as illustrated in FIG. 32. In some alternatives, the Inventory System may provide guidance as to whether or not the customer should receive credit for a return, and allow a CSR or manager to override that decision. In addition the Inventory System may track the return inspection results such that when the return is received at a centralized return facility they can be validated. In some alternatives, exception reporting may be generated if the condition of the return does not match the information that was submitted to the Inventory System at the retail store by the CSR when they processed the return. In some alternatives, the Inventory System processing the return may also trigger automated and manual processes for deactivating the customer's account with the wireless carrier.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

1. A computer-implemented method for submitting a plurality of pre-approval requests simultaneously to multiple wireless carriers, the method comprising the computer-implemented steps of:
receiving a pre-approval request from a user, wherein the pre-approval request contains an indication of the selection of multiple wireless carriers from a database of available wireless carriers and user information;
submitting the pre-approval request for processing to one or more systems for the selected multiple wireless carriers;
generating a unique indicator for the pre-approval request;
aggregating responses from the selected multiple wireless carriers;
displaying the generated unique indicator, user information and the aggregated responses on a user interface for user review and selection; and
providing the user with an option to store the displayed generated unique indicator for a future purchase of wireless products.

2. The computer-implemented method of claim 1, wherein the one or more systems communicate with third party systems.

3. The computer-implemented method of claim 2, wherein the third party system is a wireless carrier system.

4. The computer-implemented method of claim 1, wherein the user information is selected from the group consisting of: a zip code, a first name, an optional middle initial, a last name, an address, email address, date of birth, daytime phone number, home phone number, Social Security number, driver's license (or state ID) number, bank card information, payment services information and combinations thereof.

5. The computer-implemented method of claim 1, wherein the unique indicator is selected from the group consisting of: an alpha code, a numeric code, an alpha-number code, a bar code and combinations thereof.

6. The computer-implemented method of claim 1, wherein storing the displayed generated unique indicator consists of printing the displayed generated unique code or using third-party messaging applications to send the displayed generated unique code to the user or a third-party.

7. The computer-implemented method of claim 9, wherein third-party applications are selected from the group consisting of: email, voicemail, instant messaging, short message service, multimedia messaging service, other similar messaging services and combinations thereof.

8. A computer-implemented method for purchasing wireless products and services with a pre-approval code, the method comprising the computer-implemented steps of:
receiving, at a system, a unique indicator associated with a pre-approval response from multiple wireless carriers for the purchase of a wireless product and other user information from a user;
transmitting the unique indicator and the user information to at least one other system to lookup data associated with the unique indicator;
providing the unique indicator, user information and aggregated pre-approval responses from the multiple wireless carriers for display;
receiving a selection from the user of one wireless carrier from the multiple wireless carriers, wherein the selected wireless carrier provided the user with a positive pre-approval response;
displaying wireless products from a database of available wireless products from the selected wireless carrier;
receiving an order with an indication of the selected wireless product;
validating the order with one or more validation routines; and
transmitting the validated order to one or more systems for processing.

9. The computer-implemented method of claim 8, further comprising the steps of:
generating an interactive user interface if the validated order encounters a condition that requires input from a customer during the automated processing;
displaying the interactive user interface to a customer;
receiving the customer input via the interactive user interface; and
transmitting the customer input continuously to the one or more systems for additional processing, wherein the customer is engaged during the method.

10. The computer-implemented method of claim 9, wherein continuously engaged is a single user session.

11. The computer-implemented method of claim 9, wherein method is performed in real-time.

12. The computer-implemented method of claim 9, further comprising a subsequent interactive dialog providing the interactive dialog to a dynamic user interface; receiving the customer input via the interactive dialog; and transmitting the customer input continuously to the one or more systems for additional processing, for any subsequent encounter of a condition.

13. A computer implemented method for synchronizing a wireless product transaction between one or more devices, the method comprising the computer-implemented steps of:
receiving one or more components of an order from a first user with an indication of one or more selected wireless product from a database of available wireless products at a first system;
transmitting the order from the first system to a second system via a shared network connection between the first systems and the second system;
communicating any updates to the order received at the first system to the second system;
generating one or more unique indicators for the one or more components of the order at the first system;
displaying the one or more generated unique indicators at the first system; and
providing the user with an option to store the displayed generated unique indicator for a future purchase of wireless products at the second system.

14. The computer implemented method of claim 13, further comprising the steps of:
receiving at the second system, the one or more generated unique indicators;
transmitting the one or more generated unique indicators to at least one system to lookup the one or more components of the order from the first system;
providing the one or more generated indicators, the one or more components of the order for display at the second system to a second user; and
receiving input from the second user to complete the order from the first system at the second system.

15. A computer implemented method for tracking a return of a previously purchased wireless products by a user, the method comprising the computer-implemented steps of:
receiving information from a user, wherein the information contains an indication of a previously purchased wireless product to be returned at a retail store.
submitting the information for processing to one or more systems to locate a wireless product transaction associated with the previously purchased wireless product;
displaying the wireless product transaction to a user;
providing the user with a user interface to select the previously purchased wireless product from the displayed wireless transaction and record additional data about the previously purchased wireless product; and
submitting the user interface to the one or more systems for processing a return of the previously purchased wireless product and tracking the disposition of the previously purchased wireless product.

16. A computer implemented method for browsing and configuring wireless product bundles before purchasing the wireless product bundle, the method comprising the computer-implemented steps of:
displaying one or more configurable wireless options from a database of available wireless products and wireless carrier information;
receiving a selection from the one or more configured wireless options;
submitting the selected one or more configured wireless options for processing by one or more systems;
generating a unique indicator for the selected one or more configured wireless options;
displaying the generated unique indicator, information about the configured wireless options on a user interface for user review and selection; and
providing the user with an option to store the displayed generated unique indicator for a future purchase of wireless products.

17. The computer implemented method of claim 28, wherein the wireless product options are selected from the group consisting of: wireless products, wireless product accessories, wireless product plans, wireless products activation types, wireless product options, wireless product features, wireless product upsells and combinations thereof.
